(19) United States
(12) Patent Application Publication
(10) Pub. No.: US 2019/0344679 A1
(43) Pub. Date: Nov. 14, 2019

(54) DRONE TO VEHICLE CHARGE

(71) Applicant: Ford Global Technologies, LLC, Dearborn, MI (US)

(72) Inventors: Kenneth James MILLER, Canton, MI (US); Aed M. DUDAR, Canton, MI (US); Douglas Raymond MARTIN, Canton, MI (US)

(21) Appl. No.: 16/480,743

(22) PCT Filed: Jan. 30, 2017
(86) PCT No.: PCT/US17/15568

§ 371 Date: Jul. 25, 2019

(51) Int. Cl. B60L 53/38; B60L 53/12; B60Q 1/50; B60L 8/00; B60L 53/126; B60L 53/30; B64C 39/02; B64F 1/00; B64F 1/20; G01C 21/34; H02J 7/02; G06F 16/29

(52) U.S. Cl. CPC B60L 53/38; B64C 2201/18; B60Q 1/50; B60L 8/003; B60L 53/126; B60L 53/305; B64C 39/024; B64F 1/007; B64F 1/20; G01C 21/3438; H02J 7/025; G06F 16/29; B60Q 2400/40; B60L 2200/10; B64C 2201/141; B60L 53/12

(57) ABSTRACT

A vehicle charging system comprises a vehicle computer programmed actuate a vehicle charger to receive electricity from an aerial drone. Actuation of the vehicle charger is performed in response to determining the aerial drone has landed on the vehicle.

### BACKGROUND

All-electric and hybrid electric vehicles rely on an onboard source of electric energy, such as a battery, for propulsion. The propulsion may be a known vehicle propulsion subsystem, for example, an electric powertrain including an electric motor, and a transmission that transfers rotational motion to wheels of the vehicle; a hybrid powertrain including the electric motor and elements of a conventional powertrain, such as an internal-combustion engine coupled to a transmission that transfers rotational motion to wheel and the electric powertrain. A human driver can typically provide input to a propulsion controller, e.g., via an accelerator pedal Further, a vehicle computer can provide control input to a propulsion controller, whereby the propulsion may be controlled with limited or no input from the human driver, e.g., in an autonomous vehicle.

### BRIEF DESCRIPTION OF THE DRAWINGS

FIG. 1 is a perspective view of an example vehicle charging system having an example vehicle, drone, and drone transport.

FIG. 2 is a block diagram of components of an example electrical system of the vehicle of FIG. 1.

FIG. 3 is a block diagram of components of an example electrical system of the drone of FIG. 1.

FIG. 4 is a block diagram of components of an example electrical system of the drone transport of FIG. 1.

FIG. 5 is a bottom front perspective view of the drone of FIG. 1.

FIG. 6 is a perspective view of the example drone approaching the vehicle of FIG. 1.

FIG. 7 is a perspective view of the drone landed on the vehicle of FIG. 1.

FIG. 8 is a flow chart of an example process to operate the vehicle with the vehicle charging system.

FIG. 9 is a flow chart of an example process to operate the drone with the vehicle charging system.

FIG. 10 is a flow chart of an example process to operate the drone transport with the vehicle charging system.

### DETAILED DESCRIPTION

### Introduction

With reference to the Figures, wherein like numerals indicate like parts throughout the several views, the disclosed vehicle charging system 20 addresses a problem that a vehicle 100 relying on electricity for propulsion may not have access to charge an energy source of the vehicle 100 when the energy source does not contain sufficient energy to power the vehicle 100 to its destination. Accordingly, a vehicle computer 145 is programmed to actuate a charge pad 110 of the vehicle 100 to receive a charge from an aerial drone 200. The charge pad 110 is actuated in response to determining the aerial drone 200 has landed on the vehicle 200.

### System

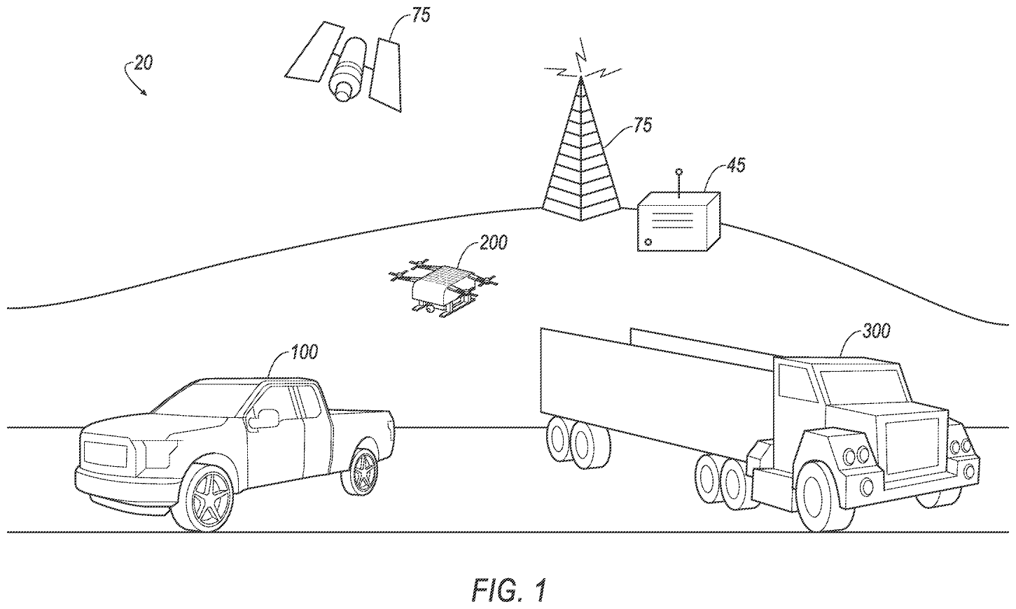

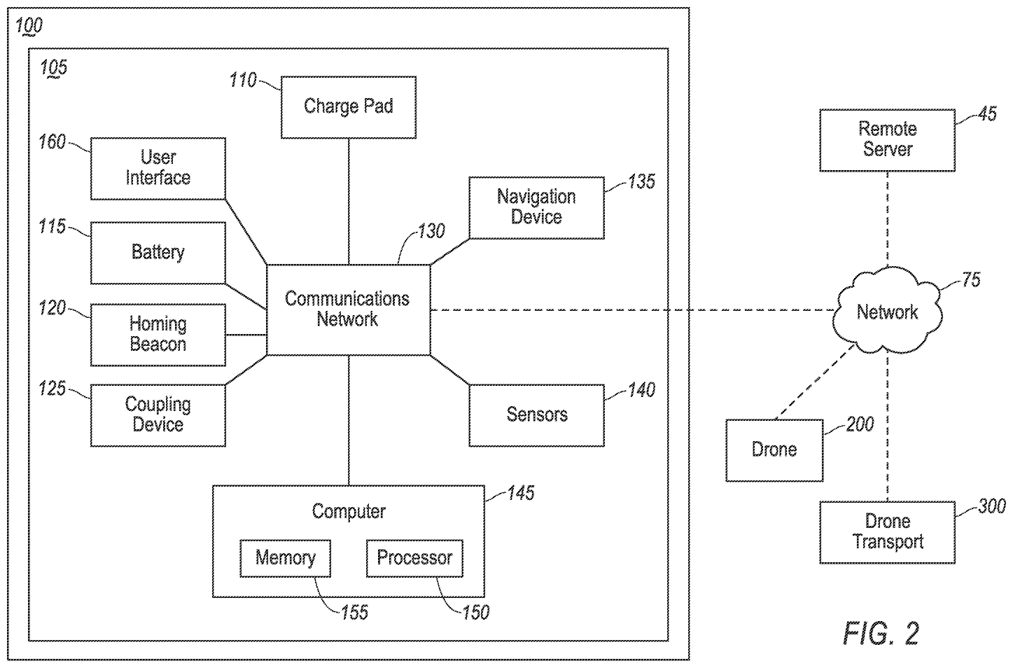

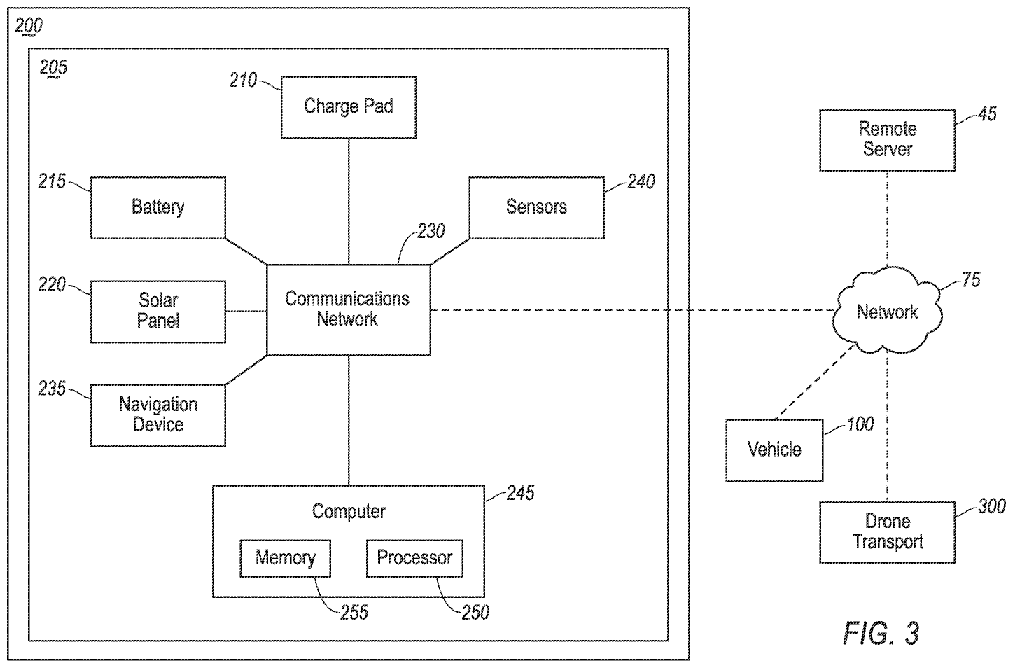

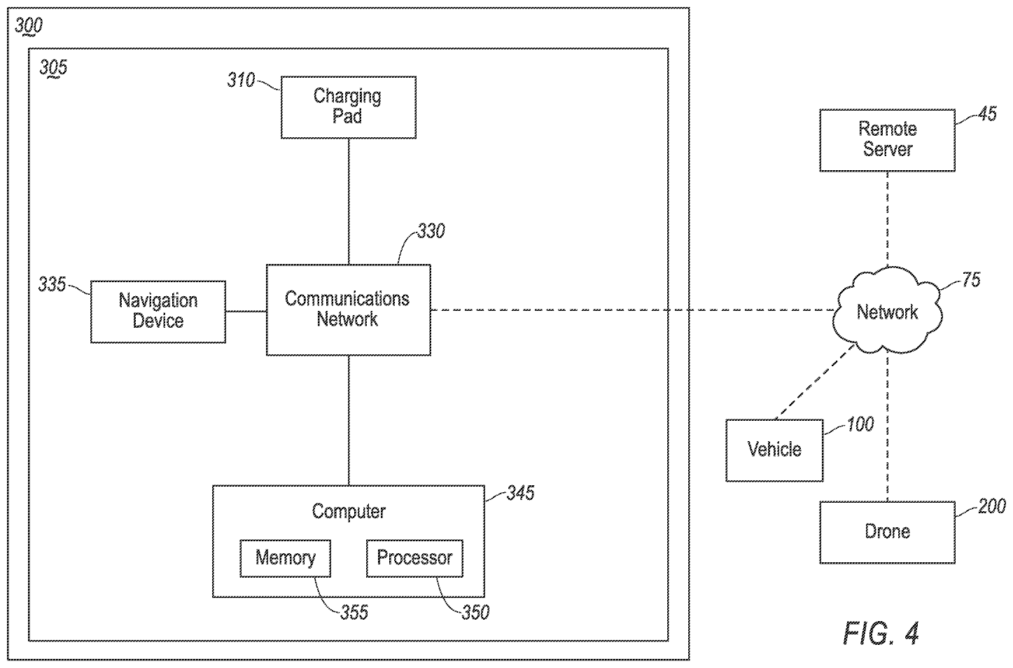

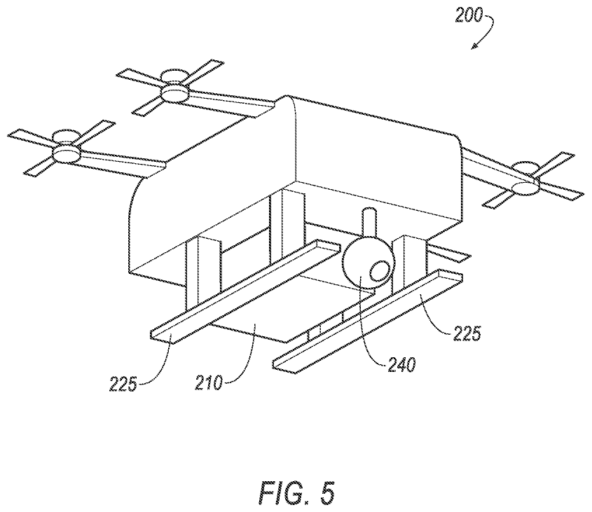

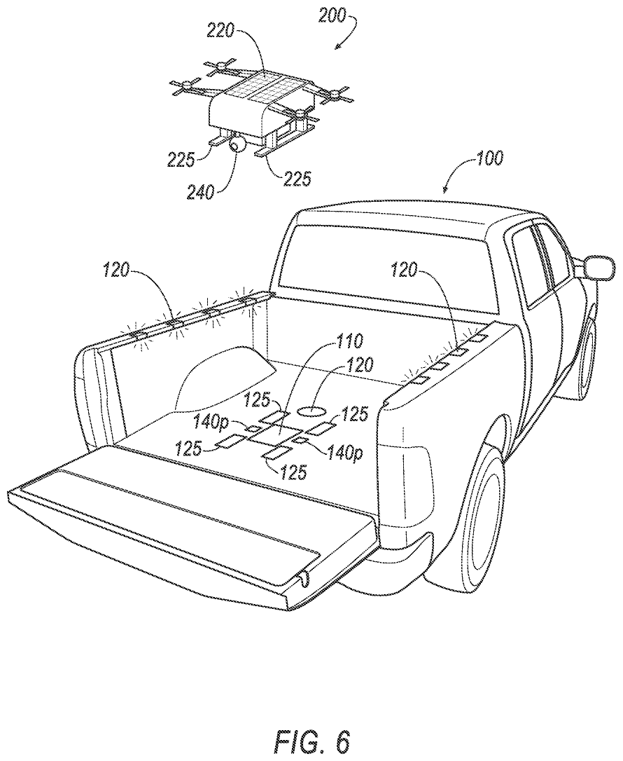

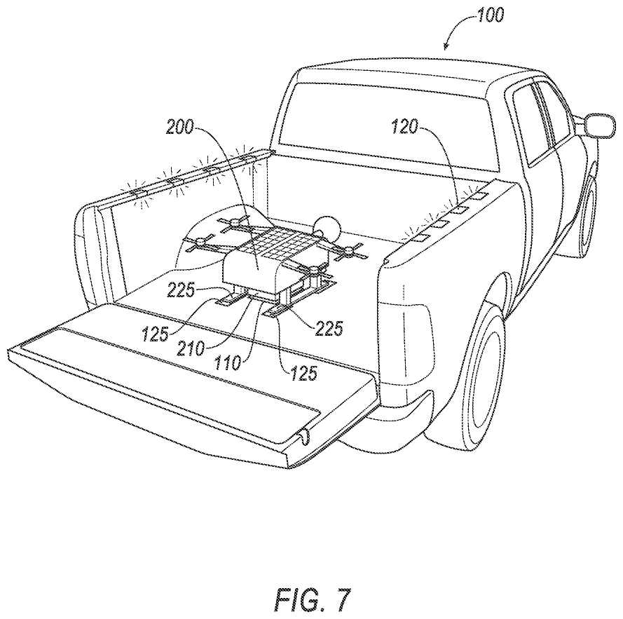

As shown in FIGS. 1-7, the charging system 20 includes the vehicle 100 having a vehicle electrical system 105 (see FIG. 2), the aerial drone 200 having an aerial drone electrical system 205 (see FIG. 3), and a drone transport 300 having a drone transport electrical system 305 (see FIG. 4). The vehicle 100, drone 200, and drone transport 300 can communicate with one another and with a remote server computer 45, sometimes referred to as a cloud server, via a network 75 and/or directly e.g., via radio frequency (RF) communications.

The server computer 45 is a computing device that includes hardware, e.g. circuits, chips, antenna, etc., programmed to transmit, receive, and process information, to and from the vehicle 100, the drone 200, and the drone transport 300, e.g., via the network 75. The server computer 45 includes a processor and a memory implemented in a manner as described below for a processor 150 and memory 155. For example, the server computer 45 may be programmed to relay and process information and communications, e.g. to receive a charge request from the vehicle 100, determine a rendezvous location based at least on the charge request (as described below), and transmit the rendezvous location to the vehicle 100 and the drone 200. The server computer 45 may use any suitable technologies, including those discussed herein.

The network 75 represents one or more mechanisms by which a vehicle computer 75 may communicate with remote devices, e.g., drone 300 and/or transport 300. Accordingly, the network 75 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

### The Vehicle

Although illustrated as a pickup truck, the vehicle 100 may be any passenger or commercial automobile with two or more wheels such as a sedan, a station wagon, a sport utility vehicle, a crossover vehicle, a van, a minivan, a taxi, a bus, etc. In sonic possible approaches, the vehicle 100 is an autonomous vehicle that can operate in an autonomous (e.g., driverless) mode, a semi-autonomous mode, and/or a non-autonomous mode. For example, a computer 145 may operate the vehicle 100 in an autonomous or semi-autonomous mode. For purposes of this disclosure, an autonomous mode is defined as one in which each of vehicle 100 propulsion (e.g., via a powertrain including an electric motor and/or an internal combustion engine), braking, and steering are controlled by the computer 145; in a semi-autonomous mode the computer 145 controls one or two of vehicle 100 propulsion, braking, and steering. The vehicle 100 may include the charge pad 110, a battery 115, a homing beacon 120, a magnetic coupling device 125, a communications network 130, a navigation device 135, sensors 140, and the computer 145.

The vehicle 100 charge pad 110 receives energy from an outside source, such as from the aerial drone 200, to be stored by the vehicle 100. The charge pad 110 may wirelessly receive the energy in one form and convert it to another form of energy, for example the charge pad 110 may receive energy in the form of a magnetic field and convert the energy to electricity, such as using known inductive charging devices and methods. The charge pad 110 may include an induction coil (such as is known and therefore not shown in the drawings). The charge pad 110 may be electrically connected to various vehicle 100 components, e.g., the battery 115 of the vehicle 100, such that electricity may flow from the charge pad 110 to the vehicle 100 component(s). The charge pad 110 may include an electronic controller, i.e., a computing device programmed to actuate the charge pad 110 to direct power to the various vehicle 100 components in response to a received command, e.g., from the computer 145. The charge pad 110 may be mounted on the vehicle 100 in a location accessible from an exterior of the vehicle 100, e.g., on a roof, trunk deck lid, truck bed, etc.

The vehicle 100 battery 115 stores electrical energy. The battery 115 may include one or more cells wired in series and/or in parallel to provide desired voltage and energy storage capacity characteristics. The battery 115 may be of any suitable type for vehicular electrification, for example, lithium-ion batteries, nickel-metal hydride batteries, lead-acid batteries, or ultracapacitors, as used in, for example, plug-in hybrid electric vehicles (PHEVs), hybrid electric vehicles (HEVs), or battery electric vehicles (BEVs).

The horning beacon 120 transmits a broadcast enabling other devices, such as the drone 200, to locate the horning beacon 120. The broadcast from the homing beacon 120 may be an electromagnetic wave in the visible or non-visible spectrum. For example, the broadcast may be light source, e.g., a light emitting diode, a laser, etc., a radio wave, etc. The horning beacon 120 may include an electronic controller, i.e., a computing device programmed to actuate the homing beacon 120 to transmit the broadcast in response to a received command, e.g., from the computer 145. The homing beacon 120 may be supported by the vehicle 100 proximate, e.g., within six inches of, the charge pad 110.

The magnetic coupling device 125 selectively provides a magnetic field to secure the aerial drone 200 to the vehicle 100. For example, the magnetic coupling device 125 may include an electromagnet that generates a magnetic field when supplied with electricity, e.g., electromagnets that include a coil of wire around ferromagnetic material such as iron. In another example, the magnetic coupling device 125 may include a switchable magnet that includes a pair permanent magnets within a housing, wherein rotation of the one permanent magnet relative to the other increases or decreases the magnetic field provided by the magnetic switch, such as MAGSWITCH® products by Magswitch Technology of Lafayette, Colo.

The magnetic coupling device 125 may include an electronic controller, i.e., a computing device programmed to actuate the magnetic coupling device 125 between an “on” state and an “off” state in response to a received command, e.g., from the vehicle 100 computer 145. In the “on” state the magnetic coupling device 125 provides the magnetic field, such as when electricity is supplied to the coil of wire or when the pair of permanent magnets are moved to the position that increase the strength of the magnetic field. In the “off” state the magnetic coupling device 125 does not provide the magnetic field, such as when no electricity is supplied to the coil of wire or when the pair of permanent magnets are moved to the position that decreases the strength of the magnetic field. One or more magnetic coupling devices 125 may be mounted to the vehicle 100 proximate to, e.g., within 12 inches of, the charge pad 110. For example, a first and a second magnetic coupling device 125 may be mounted proximate opposing sides of the charge pad 110. Spacing between the first and second magnetic coupling devices 125 may be determined based on dimensions of components of the aerial drone 200, such as spacing between the skids 225 of the drone 200.

The vehicle 100 communications network 130 includes hardware, such as a communication bus, an antenna, circuits, chips, etc., for facilitating communication within the vehicle 100 and with other vehicles (e.g., drone 200 and/or transport 300) and/or infrastructure via the network 75. The vehicle 100 communications network 130 may facilitate wired or wireless communication among the vehicle components in accordance with a number of communication protocols such as the Dedicated Short Range Communication (DSRC) communication protocol, controller area network (CAN), Ethernet, WiFi, Local Interconnect Network (LIN), and/or other wired or wireless mechanisms. The vehicle 100 communications network 130 may include a transceiver. The transceiver transmits and receives information wirelessly from other transceivers, either directly or via the network 75, enabling signals, data and other information to be exchanged with other computer and network systems. The transceiver is implemented via antennas, circuits, chips, or other electronic components that can facilitate wireless communication. Example transceivers include Wi-Fi systems, radio transmitters and receivers, telecommunications systems, Bluetooth® systems, cellular systems and mobile satellite transceivers. The transceiver may communicate with other vehicles, e.g., the aerial drone 200, the drone transport 300, etc., such as by using vehicle-to-vehicle (V2V) communications and/or via the network 75.

The vehicle 100 navigation device 135 determines a location of the vehicle 100 based on stored map data. Map data may include roads and related data, such as a number of lanes and availability of a shoulder, parking lot and public rest area locations, etc. To determine the location, the vehicle 100 navigation device 135 may rely on information from a global navigation satellite system, distance data from vehicle 100 sensors 140 attached to a drivetrain of the vehicle 100, a gyroscope, and/or an accelerometer, etc. The map data may be stored locally, such as on a vehicle memory 155, or on the vehicle 100 navigation device 135. Additionally or alternatively, the map data may be stored on a remote computer or network, accessible via the vehicle 100 communications network 130. Example vehicle 100 navigation devices 135 include known GPS (global positioning system) navigation devices, personal navigation devices, and automotive navigation devices.

The vehicle 100 sensors 140 may detect internal states of the vehicle 100, for example, wheel speed, wheel orientation, battery voltage, and engine and transmission variables. The sensors 140 may detect the position or orientation of the vehicle 100, for example, global positioning system (GPS) sensors; accelerometers such as piezo-electric or microelectromechanical systems (MEMS) sensors; gyroscopes such as rate, ring laser, or fiber-optic gyroscopes; inertial measurements units (IMU); and magnetometers. The sensors 140 may detect the external world, for example, radar sensors, proximity sensors 140p, scanning laser range finders, light detection and ranging (LIDAR) devices, and image processing sensors such as cameras. The vehicle 100 sensors 140 may include communications devices, for example, vehicle-to-infrastructure (V2I) or vehicle-to-vehicle (V2V) devices.

The vehicle 100 computer 145 is a computing device that includes a vehicle 100 processor 150 and the vehicle 100 memory 155. The vehicle 100 computer 145 is in electronic communication with, e.g., via a vehicle network 130, one or more input devices for providing data to the vehicle 100 computer 145 and one or more output devices for receiving data and/or instructions from the vehicle 100 computer 145, e.g., to actuate the output device. Example input devices include: the communications network 130, the navigation device 135, the sensors 140, etc., as well as other sensors and/or electronic control units (ECUs) that provide data to the vehicle 100 computer 145. Example output devices that may be actuated by the vehicle 100 computer 145 include: the charge pad 110, the homing beacon 120, the coupling device 125, the communications network 130, the navigation device 135, etc.

The computer 145 processor 150 (and also processors of other computing devices referenced herein) is implemented via circuits, chips, or other electronic components and may include one or more microcontrollers, one or more field programmable gate arrays (FPGAs), one or more application specific circuits (ASICs), one or more digital signal processors (DSPs), one or more custom integrated circuits, etc. The processor 150 is programmable to process the data and communications received via the communications network 130, the navigation device 135, the sensors 140, the memory 155, etc., as well as other sensors and/or electronic control units (ECUs) that provide data to the vehicle 100 computer 145, e.g., on the vehicle network 130. Processing the data and communications may include processing to: actuate the charge pad 110 of the vehicle 100 to receive a charge from the aerial drone 200 in response to determining the aerial drone 200 has landed on the vehicle 100. The vehicle 100 processor 150 may further be programmed for performing the processes described herein.

The vehicle 100 memory 155 is implemented via circuits, chips or other electronic components and can include one or more of read only memory (ROM), random access memory (RAM), flash memory, electrically programmable memory (EPROM), electrically programmable and erasable memory (EEPROM), an embedded MultiMediaCard (eMMC), a hard drive, any volatile or non-volatile media, etc. The memory 155 may store programming instructions for performing the processes described herein, and data collected from sensors and communications.

The computer 145 may be configured for interaction with a user, e.g. via a user interface 160. The user interface 160, sometimes referred to as a human-machine interface (HMI) presents information to and receives information from an occupant of the vehicle. The user interface 160 may be located, e.g., on an instrument panel in a passenger cabin of the vehicle, or wherever may be readily seen by the occupant. The user interface 160 may include dials, digital readouts, screens such as a touch-sensitive display screen, speakers, and so on for providing information to the occupant, e.g., various HMI elements. The user interface 160 may include buttons, knobs, keypads, microphone, and so on for receiving information from the occupant.

The vehicle 100 computer 145 may be programmed to determine a distance to a destination. For example, the vehicle 100 computer 145 may receive the distance to the destination from the vehicle 100 navigation device 135 via the vehicle network 130. The vehicle 100 navigation device 135 may transmit the distance to the destination to the vehicle 100 computer 145 in response to a request transmitted from the computer 145 to the navigation device 135. The computer 145 may store the distance to the destination on the memory 155.

The vehicle 100 computer 145 is typically programmed to determine an available charge range. For example, the computer 145 may identify the available charge range based on information received from vehicle 100 sensors 140, such as a battery 115 voltage sensor 140. The computer 145 may compare measured voltage of the battery 115 with a battery voltage and vehicle range correlation table stored on the vehicle 100 memory 155. The vehicle 100 can then store the available charge range on the vehicle 100 memory 155.

The vehicle 100 computer 145 is typically further programmed to determine whether the available charge range is less than the distance to the destination. For example, the computer 145 may compare the determined distance to the destination, described above, with the determined charge range, also described above.

The vehicle 100 computer 145 is further programmed to transmit a charge request, e.g., to the server computer 45, the aerial drone 200 and/or to the drone transport 300, e.g., via mechanisms that are part of the network 75 described above.

The charge request may be transmitted in response to determining that the available charge range is less than the distance to the destination. The charge request may include a location of the vehicle 100, the destination of the vehicle 100, e.g., by receiving the location and destination from the vehicle 100 navigation device 135, and the charge range, e.g., the determined charge range described above. The destination may include route information identifying a route, e.g., specific roads, the vehicle 100 intends to travel to reach the destination.

The charge request may be transmitted to, and received by, the remote server computer 45, where the remote server computer 45 determines which drone or drone transport, out of a fleet of drones and drone transports, should receive the charge request, e.g., based on a distance between home locations of the various drones, e.g., the drone transports or a fixed drone storage station, and the vehicle 100, a rendezvous location for the vehicle 100 and the drone 200, and/or the destination of the vehicle 100. The server computer 45 may determine a rendezvous location, as described below. For example, the remote server computer 45 may act as a relay and direct the charge request and/or the rendezvous location to a drone or drone transport closest to the vehicle 100.

The vehicle 100 computer 145 is typically further programmed to receive the rendezvous location, e.g., from the server computer 45, the aerial drone 200 and/or the drone transport 300, communicating via the network 75.

The vehicle 100 computer 145 may be programmed to navigate the vehicle 100 to the rendezvous location, e.g., in a fully autonomous mode. For example, the vehicle 100 computer 145 may transmit commands to vehicle powertrain, braking and steering systems via the vehicle communications network 130. The transmitted commands may be based at least on information from the vehicle 100 navigation device 135. In another example, the vehicle 100 computer 145 may provide instructions to an operator of the vehicle 100, e.g., via the user interface 160. The instructions may be based at least on information from the vehicle 100 navigation device 135.

The vehicle 100 computer 145 may be programmed to receive a beacon request, e.g., from the aerial drone 200. A beacon request is an instruction to the vehicle 100 to actuate the homing beacon 120 to transmit a broadcast. For example, the beacon request may be transmitted from the aerial drone 200 and received by the vehicle 100 via the respective communications networks 230 130.

The vehicle 100 computer 145 may be programmed to actuate a homing beacon 120 mounted on the vehicle 100, e.g., in response to a beacon request. For example, the vehicle 100 computer 145 may transmit a command, e.g., via the vehicle network 130, to the homing beacon 120 instructing the homing beacon 120 to transmit a broadcast. The vehicle 100 computer 145 may actuate the homing beacon 120 in response to receiving the beacon request, as described above.

The vehicle 100 computer 145 may be programmed to receive a landing confirmation message, e.g., from the aerial drone 200. For example, the landing confirmation message may be transmitted from the aerial drone 200 to the vehicle 100 via the communications networks 230 130.

The vehicle 100 computer 145 may be programmed to determine that the aerial drone 200 is landed on the vehicle 100. For example, the vehicle 100 computer 145 may determine that the aerial drone 200 is landed on the vehicle 100 based at least on receiving the landing confirmation. In another example, the vehicle 100 may determine that the drone 200 is landed on the vehicle 100 based at least on information received from the vehicle 100 sensors 140, e.g., information received from a proximity sensor 140p mounted on the vehicle 100 proximate, e.g., within 12 inches, the charge pad 110.

The vehicle 100 computer 145 may be programmed to actuate the magnetic coupling device 125 to the “on” state. For example, the vehicle 100 computer 145 may send a command, e.g., via the vehicle network 130, to the magnetic coupling device 125. The vehicle 100 computer 145 may actuate the magnetic coupling device 125 to the “on” state in response to determining that the aerial drone 200 has landed on the vehicle 100, as described above.

The vehicle 100 computer 145 may be programed to actuate a vehicle charger to receive electricity from the aerial drone, i.e. to actuate the vehicle 100 charge pad 110 to receive an electric charge from the aerial drone 200. For example, the vehicle 100 computer 145 may send a command to the charge pad 110 instructing the charge pad 110 to direct electricity received from the drone 200 via electromagnetic induction to the vehicle 100 battery. The vehicle 100 computer 145 may actuate the vehicle 100 charge pad 110 in response to determining that the aerial drone 200 has landed on the vehicle 100, as described above.

The vehicle 100 computer 145 may be programmed to receive a charge terminate message, e.g., from the aerial drone 200. The charge terminate message may be stored on the vehicle 100 memory 155.

The vehicle computer 145 may be programmed to determine whether the charge terminate message has been received. For example, the computer 145 may check whether the charge terminate message is stored on the memory 155.

The vehicle 100 computer 145 may be programmed to determine whether sufficient charge has been received from the aerial drone 200. For example, the vehicle 100 computer 145 may determine sufficient charge has been received based on data received from the vehicle 100 sensors 140, such as the sensor 140 measuring the voltage stored in the battery. The charge may be determined to be sufficient when the battery voltage is above a threshold amount, e.g., 375 volts. The charge may be determined to be sufficient when the battery voltage is greater than a voltage correlated with the range to the destination, such as indicated by the voltage and vehicle range correlation table described above.

The vehicle 100 computer 145 may be programmed to transmit a charge terminate message, e.g., to the aerial drone 200. The charge terminate message may be transmitted in response to determining sufficient charge has been received.

The vehicle 100 computer 145 may be programmed to actuate the magnetic coupling device 125 to the “off” state, e.g., via the vehicle network 130. The vehicle 100 computer 145 may actuate the magnetic coupling device 125 to the “off” state in response to receiving the charge terminate message. The vehicle computer may actuate the magnetic coupling device 125 to the “off” state in response to determining sufficient charge has been received.

### The Aerial Drone

The drone 200 is an unmanned aerial vehicle (UAV) and includes a computing device, such as a drone computer 245 that may include a number of circuits, chips, or other electronic components that can control various operations of the drone 200. For instance, the drone 200 may fly in accordance with control signals output to its propeller motors. The drone 200 may include a charge pad 210, a battery 215, a photovoltaic solar panel 220, one or more skids 225, the communications network 230, a navigation device 235, one or more sensors 240, and the drone 200 computer 245.

The drone 200 charge pad 210 receives and transmits energy from and to an outside source, such as from the drone transport 300 and to the vehicle 100. The drone 200 charge pad 210 may wirelessly receive the energy in one form and convert it to another form of energy, for example the drone 200 charge pad 210 may transmit or receive energy in the form of an electromagnetic field and convert the energy to electricity, such as using known inductive charging devices and methods. The drone 200 charge pad 210 may include an induction coil (such as is known and therefore not shown in the drawings). The drone 200 charge pad 210 is electrically connected to various drone 200 components, e.g., a battery 215 of the drone 200, such that electricity may flow to and from the charge pad 210 to the drone 200 component(s). The drone 200 charge pad 210 further typically includes an electronic controller, i.e., a computing device programmed to actuate the drone 200 charge pad 210 to direct power to and from the various drone 200 components in response to a received command, e.g., from the drone 200 computer 245. The drone 200 charge pad 210 may be mounted on the drone 200, e.g., supported hanging from an underside of the drone 200.

The drone 200 battery 215 stores electrical energy. The battery 215 may include one or more cells wired in series and/or in parallel to provide desired voltage and energy storage capacity characteristics. The battery 215 may be of any suitable type for aerial drone electrification, for example, lithium-ion batteries, nickel-metal hydride batteries, lead-acid batteries, or ultracapacitors.

The skids 225 provide support to the drone 200 to maintain an upright position when the drone 200 is landed, i.e., supported by a surface. The skids 225 typically support the drone 200 such that the drone 200 charge pad 210 is a predetermined distance, e.g., 5 millimeters, from the surface on which the drone 200 is landed. The skids 225 may extend downwardly from a main body of the drone 200. The skids 225 may be magnetically coupleable, e.g., formed of a ferromagnetic material, a permanent magnet material, and/or include a magnetic coupling device, similar to that described above. Example ferromagnetic materials include iron, nickel, cobalt, etc. Example permanent magnet materials include alnico, ferrite, etc.

The photovoltaic solar panel 220 converts light energy to electricity. The solar panel 220 is electrically connected to various drone 200 components, e.g., the battery 215 of the drone 200, such that electricity may flow from the solar panel 220 to the drone components.

The drone 200 the communications network 230, includes hardware, such as an antenna, circuits, chips, etc., for providing communication within the drone 200, with other computing devices, e.g., the server computer 45, and with other vehicles (e.g., vehicle 100 and/or transport 300) and/or infrastructure via the network 75. The drone 200 communications network 230 may use any suitable technologies, including such as already discussed herein.

The drone 200 navigation device 235 determines a location of the drone 200 based on stored map data and a determined location of the drone 200, e.g., according to a GPS (global positioning system) navigation device, inertial tracking, a gyroscope, and/or an accelerometer, etc. Map data may include roads and related data, such as a building and other structures that might imped a flight path of the drone 200, no-fly zones, etc. The map data may be stored locally, such as in a drone memory 255 or drone 200 navigation device 235. Additionally or alternatively, the map data may be stored on a remote computer or network, accessible via the network 75.

The drone 200 sensors 240 may detect internal states of the drone 200, for example, propeller speed, drone 200 battery 215 charge level, power consumption rates, etc. The sensors 240 may detect the position or orientation of the drone 200, for example, global positioning system (GPS) sensors; accelerometers such as piezo-electric or microelectromechanical systems (MEMS) sensors; gyroscopes such as rate, ring laser, or fiber-optic gyroscopes; inertial measurements units (IMU); and magnetometers. The sensors 240 may detect the external world, for example, radar sensors, scanning laser range finders, light detection and ranging (LIDAR) devices, and image processing sensors such as cameras. The drone 200 sensors 240 may include communications devices, for example, vehicle-to-infrastructure (V2I) or vehicle-to-vehicle (V2V) devices.

The drone 200 computer 245 is a computing device that includes a processor 250 and the memory 255. The drone 200 computer 245 is in electronic communication with one or more input devices for providing data to the drone 200 computer 245 and one or more output devices for receiving data and/or instructions from the drone 200 computer 245, e.g., to actuate the output device. Example input devices include: the communications network 230, the navigating device 235, the sensors 240, etc. as well as other sensors and/or electronic control units (ECUs) that provide data to the drone 200 computer 245. Example output devices that may be actuated by the drone 200 computer 245 include: the charge pad 210, the solar panel 220, the communications network 230, the navigation device 235, etc.

The drone 200 processor 250 is implemented in a manner as described above for the processor 150.

The drone 200 memory 255 is implemented in a manner as described above for other memories mentioned in this disclosure. The memory 255 may store a drone range and charge level look up table correlating various levels of battery 215 charge with an associated range of flight for the drone 200.

The drone 200 computer 245 may be programmed to receive a charge request via the network 75, e.g., from the server computer 45, the vehicle 100 and/or the drone transport 300. The charge request may include the charge range and the destination of the vehicle 100, as described above.

The drone 200 computer 245 may be programmed to determine the rendezvous location based at least on the charge range and the destination of the vehicle 100. For example, the drone 200 computer 245 may determine a location closest to the drone 200 along the route to the destination of the vehicle 100 and within the charge range, such as based at least on information from the drone 200 navigation device 235.

The drone 200 computer 245 may be programmed to receive the rendezvous location, e.g., from the server computer 45, and/or drone transport 300 via the network 75.

The drone 200 computer 245 may be programmed to navigate the drone 200 to the rendezvous location. For example, the drone 200 computer 245 may transmit commands to the propeller motors to propel the drone in a direction of the rendezvous location. The drone 200 may be navigated to avoid structures, such as buildings. The transmitted commands may be based at least on information from the drone 200 navigation device 235 and drone 200 sensors, such as a current location of the drone 200, locations of structures, etc.

The drone 200 computer 245 may be programmed to land on the vehicle 100. For example, the drone 200 computer 245 may transmit commands to propeller motors to approach and land on the vehicle 100. The drone 200 computer 245 may control the propeller motors based on information received from the drone 200 sensors 240. For example, the drone 200 sensors 240 may detect the broadcast from the homing beacon 120, such as a light detection device detecting a broadcasted light. The drone 200 computer 245 may navigate the drone 200 toward the homing beacon 120 to land the drone in a location proximate to, e.g., within six inches of, the homing beacon 120.

The drone 200 computer 245 may be programmed to transmit a landing confirmation message, e.g., to the vehicle 100, e.g., via the network 75 or, more typically, via a direct RF communication, e.g., via communications network 230. The landing confirmation message may be transmitted in response to the drone 200 being proximate to, e.g., within 21 inches of, the homing beacon 120.

The drone 200 computer 245 may be programmed to actuate the drone 200 charge pad 210 to transmit an electric charge from the aerial drone 200. For example, the drone 200 computer 245 may send a command to the charge pad 210 instructing the charge pad 210 to receive electricity from the drone 200 battery. The electricity may be converted to a magnetic field received by the vehicle 100 charge pad 110.

The drone 200 computer 245 may be programmed to transmit the charge terminate message, e.g., to the vehicle 100, e.g., via the network 75 or, more typically, via a direct RF communication, e.g., via the communications network 230.

The charge terminate message may be transmitted based on a charge level of the drone 200 battery 215. For example, the drone 200 sensors 240 may detect the voltage of the drone 200 battery 215, and the drone 200 computer 245 may transmit the terminate charge message when the voltage is below a threshold level, e.g., 21 volts. The threshold level may be determined by the manufacturer and stored in the drone 200 memory 255. The threshold level may be determined by the drone 200. For example, the computer 245 may determine a distance between a current location of the drone 200 and a home location of the drone 200, e.g. a location of the drone transport 300, based at least on information received from the navigation device 235. The location of the drone transport 300 may be received by the computer 245 from the drone transport, e.g. via the communications networks 230 330 and/or the network 75. To determine the threshold level, the computer 245 may compare the determined distance with the drone range and charge level look up table stored on the memory 255.

The drone 200 computer 245 may be programmed to receive the charge terminate message, e.g., from the vehicle 100.

The drone 200 computer 245 may be programmed to navigate the drone 200 to the home location. For example, the drone 200 computer 245 may transmit commands to the propeller motors to propel the drone in a direction of the home location. The drone 200 may be navigated to avoid structures, such as buildings. The transmitted commands may be based at least on information from the drone 200 navigation device 235 and drone 200 sensors, such as a current location of the drone 200, locations of structures, etc. The home location may be stored in the drone 200 memory 255.

The drone 200 computer 245 may be programmed to receive an electric charge from the drone transport 300. For example, the drone 200 computer 245 may send a command to the charge pad 210 instructing the charge pad 210 to direct electricity from the charge pad 210 to the drone 200 battery 215.

### The Drone Transport

The drone transport 300 supports one or more aerial drones 200, providing a location for the drones 200 to be stored and charged when not in use, and a way to transport drones 200 to high use areas without using energy from the drone 200 battery 215. Although illustrated as a truck and trailer, the drone transport 300 may include any passenger or commercial automobile having three or more wheels such as a car, a truck, a sport utility vehicle, a crossover vehicle, a van, a minivan, a taxi, a bus, etc. in some examples, the drone transport 300 is an autonomous vehicle that can operate in an autonomous (e.g., driverless) mode, a semi-autonomous mode, and/or a non-autonomous mode. The drone transport 300 may include a charge pad 310, a communications network 330, a navigation device 335, and a computer 345.

The drone transport 300 charge pad 310 transmits energy to an outside source, such as to the aerial drone 200. The charge pad 310 may receive the energy in one form, convert it to another form, and wirelessly transmit the converted energy. For example, the charge pad 310 may receive electricity and convert the electricity to a magnetic field, such as using known inductive charging devices and methods. The drone transport 300 charge pad 310 may include an induction coil (such as is known and therefore not shown in the drawings). The drone transport 300 charge pad 310 may be electrically connected to various drone transport 300 components, e.g., a battery or generator of the drone transport 300, such that electricity may flow to the charge pad 310 from the drone transport 300 component(s). The charge pad 310 may include an electronic controller, i.e., a computer programmed to actuate the charge pad 310 to wirelessly transmit energy in response to a received command, e.g., from the drone transport 300 computer 345. The drone transport 300 charge pad 310 may be mounted on the drone transport 300 in a location accessible by the drone 200.

The drone transport 300 communications network 330 includes hardware, such as an antenna, circuits, chips, etc., for providing communication within the transport 300, with other computing devices, e.g. the server computer 45, and with other vehicles (e.g., the vehicle 100 and/or drone 200) and/or infrastructure via the network 75. The transport 300 communications network 330 may use any suitable technologies, including such as already discussed herein.

The drone transport 300 navigation device 335 determines a location of the drone transport 300 based on stored map data, e.g., as described above concerning the vehicle 100.

The drone transport 300 computer 345 is a computing device that includes a drone transport 300 processor 350 and the drone transport 300 memory 355. The drone transport 300 computer 345 is in electronic communication with one or more input devices for providing data to the drone transport 300 computer 345 and one or more output devices for receiving data and/or instructions from the drone transport 300 computer 345, e.g., to actuate the output device. Example input devices include: the communications network 330, the navigation device 335, etc., as well as other sensors and/or electronic control units (ECUs) that provide data to the drone transport 300 computer 345. Example output devices that may be actuated by the drone transport 300 computer 345 include: the charge pad 310 etc.

The drone transport 300 processor 350 is implemented in a manner as described above for the processor 150.

The drone transport 300 memory 355 is implemented in a manner as described above for the memory 155.

The drone transport 300 computer 345 may be programmed to actuate the drone transport 300 charge pad 310 mounted on the drone transport 300, e.g., by sending a command to the charge pad 310, to provide a charge to the aerial drone 200 via electromagnetic induction, as described above.

The drone transport 300 computer 345 may be programmed to receive the charge request e.g., from the vehicle 100 via the network 75. The charge request may include the charge range and the destination of the vehicle 100, as described above. The drone transport 300 computer 345 may further be programmed to then transmit the charge request, e.g., to the aerial drone 200 via the network 75. The drone transport 300 computer 345 may be programmed to determine the rendezvous location based at least on the charge range and the destination of the vehicle 100. For example, the drone transport 300 computer 345 may determine a location closest to the drone transport 300 along the route to the destination of the vehicle 100 and within the charge range, such as based at least on information from the drone transport 300 navigation device 335. The drone transport 300 computer 345 may be programmed to transmit the rendezvous location e.g., to the aerial drone 200 via the network 75.

The drone transport 300 computer 345 may be programmed to transmit the location of the drone transport 300, e.g., via the communications network 330 and the network 75. The computer 345 may determine the location of the drone transport 300 based at least on information from the navigation device 335.

### Processes

### The Vehicle

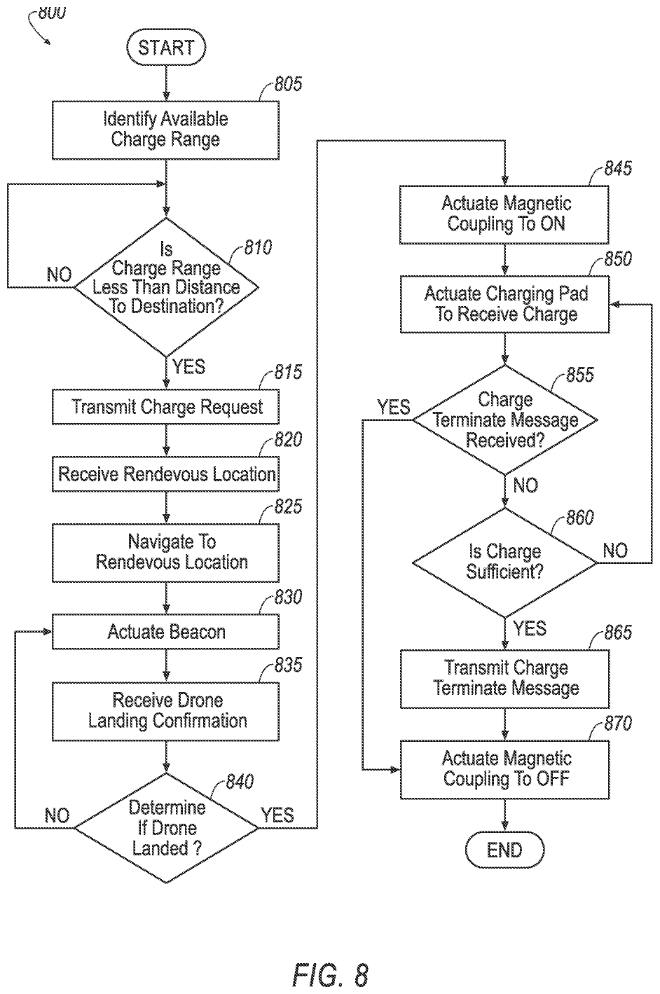

FIG. 8 is a process flow diagram illustrating an exemplary process 800 for operating the vehicle 100 to receive the charge from the drone 200. The process 800 begins in a block 805 when the vehicle is powered on or is otherwise activated, at periodic intervals, e.g., every 5 minutes, while the vehicle 100 is operating, when a destination is input into to vehicle 100, etc.

The block 805 the vehicle 100 computer 145 determines an available charge range of the vehicle 100. For example, the computer 145 may compare a measured voltage of the vehicle 100 with a battery voltage and vehicle range correlation table stored on the vehicle 100 memory 155.

At a block 810 the vehicle 100 computer 145 determines whether the charge range is less than the distance to the destination of the vehicle 100. For example, the computer 145 may compare the determined distance to the destination with the determined charge range.

At the block 815, upon determining that the charge range is less than the distance to the destination, the vehicle 100 computer 145 transmits the charge request, e.g., via the network 75. The charge request may be transmitted from the vehicle 100 to the server computer 45. The server computer may identify the drone 200 and/or drone transport closest to the vehicle 100, the vehicle destination, or a location there between, e.g., based on the charge range, and transmit the charge request to such drone 200 and/or drone transport 300.

At a block 820 the vehicle 100 computer 145 receives the rendezvous location, e.g., via the network 75.

At a block 825 the vehicle 100 computer 145 navigates the vehicle 100 to the rendezvous location. For example, the computer 145 may transmit commands to vehicle powertrain, braking and steering systems based at least on information received from the navigation device 135. In another example, the computer 145 instructs a human driver, e.g., via the user interface, based at least on information received from the navigation device 135.

At a block 830 the vehicle 100 computer 145 actuates the homing beacon 120.

At a block 835 the vehicle 100 computer 145 receives the drone landing confirmation.

At a block 840 the vehicle 100 computer 145 determines whether the drone 200 has landed on the vehicle 100. For example, the computer 145 may determine the drone 200 has landed based at least on the landing confirmation, and/or information received from the proximity sensor 140p.

At the block 845 the vehicle 100 computer 145 actuates the coupling device 125 to the “on” state.

At a block 850 the vehicle 100 computer 145 actuates the charge pad 110 to receive a charge from the drone 200.

At a block 855 the vehicle 100 computer 145 determines whether the charge terminate message was received, e.g., is stored on the memory 155.

At the block 860 the vehicle 100 computer 145 determines whether the vehicle 100 has received sufficient charge, e.g., as described above.

At the block 856 the vehicle 100 computer 145 transmits the charge terminate message.

At the block 870 the vehicle 100 computer 145 actuates the coupling device 125 to the “off” state. For example, the computer 145 may send a command to the coupling device 125 via the vehicle network 130. After the block 870 the process 800 ends.

### The Aerial Drone

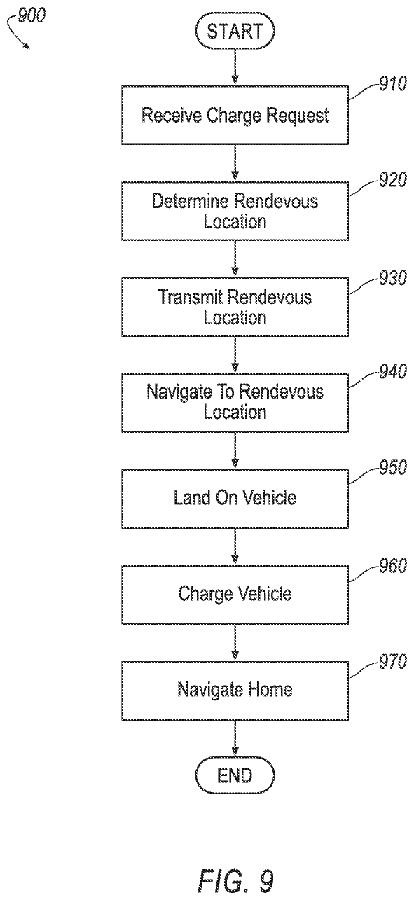

FIG. 9 is a process flow diagram illustrating an exemplary process 900 for operating the drone 200 to provide a charge to the vehicle 100. The process 900 may begin in a block 910 when the drone 200 is powered on.

At the block 910 the drone 200 computer 245 receives the charge request and/or the rendezvous location, e.g., from the server computer 45 and/or the drone transport 300 via the network 75.

At a block 920 the drone 200 computer 245 determines the rendezvous location, e.g., as described above.

At a block 930 the drone 200 computer 245 transmits the rendezvous location.

At a block 940 the drone 200 computer 245 navigates the drone 200 to the rendezvous location.

At a block 950 the drone 200 computer 245 lands the drone 200 on the vehicle 100.

At a block 960 the drone 200 computer 245 actuates the charge pad 210 to provide a charge to the vehicle 100.

At a block 970 the drone 200 computer 245 navigates the drone 200 to the home location. After the block 970, the process 900 ends.

### The Drone Transport

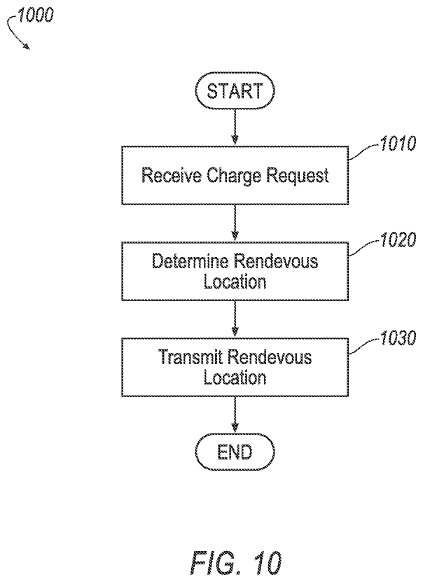

FIG. 10 is a process flow diagram illustrating an exemplary process 1000 for operating the drone transport 300 to aid in providing the charge to the vehicle 100 from the drone 200. The process 1000 may begin in a block 1010 when the drone transport is powered on.

At the block 1010 the drone transport 300 computer 345 receives the charge request.

Next, at a block 1020 the drone transport 300 computer 345 determines the rendezvous location.

At a block 1030 the drone transport 300 computer 345 transmits the rendezvous location.

### CONCLUSION

Computing devices as discussed herein generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

1. A system comprising, a vehicle computer programmed to:
in response to determining an aerial drone has landed on a vehicle, actuate a vehicle charger to receive electricity from the aerial drone.

2. The system of claim 1, the vehicle computer further programmed to:
determine whether an available charge range is less than a distance to a destination; and
in response to determining the available charge range is less than the distance to the destination, transmit a charge request.

3. The system of claim 2, wherein the charge request includes the destination and the charge range.

4. The system of claim 1, the vehicle computer further programmed to:
receive a rendezvous location message identifying a rendezvous location; and
navigate to the rendezvous location.

5. The system of claim 1, the vehicle computer further programmed to:
actuate a homing beacon mounted on the vehicle.

6. The system of claim 1, the vehicle computer further programmed to:
actuate a magnetic coupling device mounted on the vehicle to an on state in response to determining the aerial drone has landed on the vehicle.

7. The system of claim 1, wherein determining the aerial drone has landed on the vehicle is based at least on a landing confirmation message from the aerial drone.

8. The system of claim 1, further comprising:
the electromagnetic induction charge pad.

9. The system of claim 1, further comprising:
an aerial drone including an electromagnetic induction charge pad and a magnetically coupleable landing skid.

10. The system of claim 9, the aerial drone comprising:
a photovoltaic solar panel.

11. The system of claim 1, further comprising:
a magnetic coupling device mounted to the vehicle proximate the charge pad; wherein
the vehicle computer is further programmed to actuate the magnetic coupling device to an on state in response to determining the aerial drone has landed on the vehicle.

12. The system of claim 1, further comprising:
a server computer programmed to determine a rendezvous location.

13. The system of claim 2, further comprising:
a server computer programed to receive the charge request.

14. The system of claim 13, the server computer further programmed to transmit the charge request.

15. The system of claim 1, further comprising:
a drone transport including an electromagnetic induction charge pad mounted on the drone transport.

16. A method comprising:
in response to determining an aerial drone has landed on a vehicle, actuating vehicle charger to receive electricity from the aerial drone.

17. The method of claim 16, further comprising:
determining whether an available charge range is less than a distance to a destination; and
in response to determining the available charge range is less than the distance to the destination, transmitting a charge request.

18. The method of claim 16, further comprising:
receiving a rendezvous location message identifying a rendezvous location; and
navigating to the rendezvous location.

19. The method of claim 16, further comprising:
actuating a homing beacon mounted on the vehicle.

20. The method of claim 16, further comprising:
actuating a magnetic coupling device mounted on the vehicle to an on state in response to determining the aerial drone has landed on the vehicle.
